(19) United States
(12) Patent Application Publication
(10) Pub. No.: US 2026/0340246 A1
(43) Pub. Date: Oct. 29, 2026

(54) Recognition-Enhanced Density-Functional and GW Electronic-Structure Solvers - Methods and Systems for Parameter-Free Exchange-Correlation Kernel Scaling Using the Recognition-Physics Loop Correction

(71) Applicant: Jonathan Washburn, Austin, TX (US)

(72) Inventor: Jonathan Washburn, Austin, TX (US)

(21) Appl. No.: 19/652,804

(22) Filed: Apr. 20, 2026

Related U.S. Application Data
(60) Provisional application No. 63/794,439, filed on Apr. 25, 2025.

(51) Int. Cl. G06F 30/3308

(52) U.S. Cl. CPC G06F 30/3308

(57) ABSTRACT

Methods, systems, and computer-readable media are disclosed for improving electronic-structure solvers using parameter-free exchange-correlation correction applied before iterative solution. A correction parameter is computed according to delta_loop=X_opt\hat{ }(1+R_RP), where phi=(1+sqrt(5))/2, X_opt=phi/pi, and R_RP=7/12, and a loop multiplier is computed according to lambda_loop=1−delta_loop. Before a first iterative solver cycle begins, the loop multiplier is applied to at least one exchange-related quantity and at least one correlation-related quantity of an electronic-structure workflow. In some embodiments, the correction is applied in density-functional theory, hybrid density-functional theory, or GW workflows to improve convergence behavior and electronic-property prediction without empirical material-specific fitting.

### CROSS-REFERENCE TO RELATED APPLICATIONS

This application claims the benefit of U.S. Provisional Patent Application No. 63/794,439, filed on Apr. 25, 2025, the disclosure of which is incorporated herein by reference to the extent permitted and not inconsistent with the present disclosure.

### BACKGROUND OF THE INVENTION

The present invention generally relates to computational materials science and electronic-structure calculation. More particularly, the present invention relates to Kohn-Sham density-functional theory (DFT), hybrid density-functional methods, and many-body GW quasiparticle solvers, and to methods, systems, and computer-readable media for parameter-free pre-scaling of exchange-correlation kernels and related operators before iterative electronic-structure solution. In particular embodiments, the disclosed technology applies a recognition-derived correction factor to exchange and correlation quantities prior to a first self-consistent iteration in order to improve convergence behavior and electronic-property prediction without reliance on empirically tuned mixing parameters.

Electronic-structure solvers are widely used in materials discovery, semiconductor design, molecular modeling, battery research, optoelectronic device development, and related computational workflows. In many practical settings, Kohn-Sham DFT serves as a baseline computational tool because it can provide tractable approximations for total energy, charge density, density of states, band structure, and related observables across a broad range of material systems. However, conventional local-density and generalized-gradient approximations often exhibit systematic error in predicted band gaps and related excited-state properties. In particular, such approaches frequently underestimate band gaps for semiconductors and insulators, thereby limiting predictive accuracy in workflows that depend on reliable electronic-property estimation. Hybrid density-functional methods improve on some of these deficiencies by introducing a contribution from exact exchange. In practice, however, such hybrid methods typically rely on empirically selected or conventionally adopted exchange-mixing fractions. Those fractions do not arise as universal first-principles constants within standard solver implementations and may vary in effectiveness across different classes of materials. A mixing value that improves results for one material system may be suboptimal for another, which can make calibration, transferability, and reproducibility more difficult in broad screening or production environments. As a result, conventional hybrid approaches often trade one source of inaccuracy for another by substituting empirically chosen tuning parameters for a more general parameter-free correction mechanism.

Many-body GW methods and related quasiparticle correction techniques can provide improved accuracy, but such methods are often computationally expensive and may require repeated self-consistent or partially self-consistent cycles. Likewise, hybrid DFT and GW workflows may incur substantial computational cost due to repeated Hamiltonian construction, diagonalization, mixing, screening evaluation, or self-energy updates. In practice, the number of iterations needed to reach convergence can materially affect wall time, accelerator utilization, power consumption, and throughput, particularly in high-throughput computational pipelines or large-cell simulations. Consequently, there remains a need for techniques that improve convergence behavior without requiring substantial restructuring of existing solver architectures. Accordingly, there is a need for improved methods, systems, and computer-readable media that provide a deterministic, parameter-free correction for electronic-structure solvers, including DFT, hybrid DFT, and GW solvers, while remaining compatible with existing code architectures and iterative solution workflows. There is a further need for such techniques to be implementable as compact patches, linked modules, plugins, or equivalent software components that can operate before the principal self-consistent loop begins, thereby improving convergence behavior and electronic-property prediction without requiring empirical material-by-material fitting. The embodiments disclosed herein address these and other technical problems.

In some embodiments, the disclosed technology improves computer operation and electronic-structure computation not by merely reporting a mathematical result, but by changing the machine-executed initialization state of an iterative solver before the principal iterative cycle begins. In representative implementations, the disclosed pre-first-iteration scaling reduces residual oscillation, reduces repeated ineffective iteration, improves convergence behavior of self-consistent workflows, and enables more efficient use of processor, accelerator, memory, and runtime resources in electronic-structure calculations. These technical effects arise from the disclosed placement and application of the parameter-free loop multiplier within the solver architecture, rather than from presentation of information alone.

### SUMMARY OF THE INVENTION

The present disclosure provides methods, systems, and computer-readable media for improving electronic-structure solvers through parameter-free exchange-correlation correction applied before iterative solution. In representative embodiments, a correction parameter is computed as delta_loop=X_opt\hat{ }(1+R_RP), where phi=(1+sqrt(5))/2, X_opt=phi/pi, and R_RP=7/12, and a loop multiplier is then computed as lambda_loop=1−delta_loop. The disclosed technology applies lambda_loop to exchange and correlation quantities before a first self-consistent iteration so that the solver begins from a corrected exchange-correlation representation rather than relying on an empirically selected mixing parameter.

In one aspect, the disclosure provides a computer-implemented method in which an exchange kernel and a correlation kernel are scaled by lambda_loop prior to execution of a self-consistent Kohn-Sham, hybrid DFT, or related electronic-structure workflow. In representative implementations, the scaling is performed once before the first self-consistent-field iteration, after which the solver proceeds without further iterative rescaling of the corrected kernels. The method may then output one or more electronic-structure properties, including, by way of example, band structure, band gap, total energy, density of states, charge density, quasiparticle energy, or related observables.

In another aspect, the disclosure provides a system, software module, plugin, patch set, injector, or linked library configured to integrate with an existing host electronic-structure code. In certain embodiments, the disclosed correction may be implemented using an in-place vector-scaling operation on reciprocal-space or real-space arrays, including one or more BLAS scaling calls or equivalent array operations. Representative host environments include plane-wave DFT codes, hybrid DFT codes, quasiparticle solvers, and related computational materials-science platforms. In some embodiments, the disclosed technology may be incorporated into existing workflows with limited code changes and without modification of core FFT libraries, diagonalization routines, mixing logic, or input/output infrastructure.

In a further aspect, the disclosure provides a non-transitory computer-readable medium storing instructions that, when executed by one or more processors, cause a computing system to compute the correction parameter, scale one or more exchange-correlation quantities, execute an iterative electronic-structure solver using the scaled quantities, and generate one or more output properties. The instructions may be executed on a workstation, cluster node, GPU-enabled server, cloud instance, or other computing environment suitable for electronic-structure simulation.

In additional embodiments, the disclosed correction is applied in a GW context. For example, the same parameter-free correction may be applied to a screened interaction, an inverse dielectric representation, a self-energy term, or combinations thereof. In representative embodiments, the correction may be used in one-shot G0W0 workflows, self-consistent GW workflows, or starting-point correction workflows in which a scaled screening-related quantity improves convergence and/or quasiparticle prediction. Thus, the disclosed technology is not limited to exchange-correlation kernel scaling in a Kohn-Sham loop, but also extends to related operators used in many-body perturbation approaches.

In still further embodiments, the disclosed technology may be adapted to alternative solver classes and downstream computational environments. By way of example, disclosed embodiments encompass all-electron codes in which scaling is applied to a real-space exchange-correlation potential or analogous quantity, time-dependent density-functional theory implementations in which a time-dependent exchange-correlation kernel is scaled, and quantum Monte Carlo implementations in which a Jastrow-related quantity is scaled. Additional embodiments include use in machine-learning force-field generation, high-throughput materials screening, cloud-based simulation services, and electronic design automation or technology computer-aided design workflows that benefit from improved electronic-property predictions generated by the disclosed solver corrections.

Although the disclosed correction framework may be adapted to multiple solver classes and deployment contexts, the present disclosure does not require every embodiment to support every solver family, every host code, every operator type, every deployment architecture, or every downstream use case. In some embodiments, the disclosed technology is implemented only in a Kohn-Sham or hybrid DFT workflow. In some embodiments, the disclosed technology is implemented only in a GW workflow. In some embodiments, additional solver classes, deployment modes, or downstream integrations are selectively included or omitted according to the intended implementation while preserving the disclosed common inventive concept of parameter-free pre-iteration correction using the disclosed loop multiplier.

In representative benchmarks and implementations described herein, the disclosed technology reduces self-consistent iteration counts, reduces wall time, reduces error relative to experimental band-gap values, and introduces negligible additional memory overhead, while preserving deterministic output for deterministic inputs. Such benchmark results are presented as illustrative embodiments and representative implementations rather than as absolute limitations or guarantees for every material system or solver configuration. The disclosed subject matter accordingly provides a practical and parameter-free correction framework that can be integrated into existing electronic-structure solvers while supporting examiner review, implementation, and prosecution through a self-contained written description, figure set, and detailed embodiment disclosure.

The disclosed embodiments share a common inventive concept in that a deterministically derived, parameter-free loop multiplier is computed from the disclosed relations and applied prior to iterative solver execution to establish a corrected representation before the iterative loop begins. In representative embodiments, the same correction framework is applied to different solver operators, including exchange-correlation quantities in a Kohn-Sham or hybrid DFT context and screening or self-energy related quantities in a GW context, without requiring empirical material-by-material fitting.

### BRIEF DESCRIPTION OF THE DRAWINGS

FIG. 1 is a block diagram of a recognition-enhanced electronic-structure solver environment. In representative embodiments, FIG. 1 illustrates how a structure input is provided to a host electronic-structure solver together with a recognition-derived correction engine that computes and applies a parameter-free scaling factor prior to iterative solution. FIG. 1 also shows representative interfaces for result generation, user interaction, and provenance or verification support.

FIG. 2 is a block diagram of a correction-parameter derivation and certification workflow. In representative embodiments, FIG. 2 illustrates computation of phi, X_opt, R_RP, delta_loop, and lambda_loop, together with optional caching, certification, theorem-verification, or provenance interfaces. FIG. 2 therefore shows a representative deterministic pathway for obtaining the disclosed scaling value before solver execution.

FIG. 3 is a block diagram of reciprocal-space exchange-correlation kernel scaling. In representative embodiments, FIG. 3 illustrates application of lambda_loop to exchange and correlation kernel arrays prior to a first self-consistent-field iteration. FIG. 3 further shows how scaled kernel quantities are supplied to exchange-correlation assembly and Hamiltonian or potential construction stages.

FIG. 4 is a flow diagram of a self-consistent-field process including a pre-first-iteration scaling stage. In representative embodiments, FIG. 4 illustrates a solver workflow in which a corrected exchange-correlation representation is established before the iterative loop begins, after which Hamiltonian construction, diagonalization, density update, mixing, and convergence evaluation proceed. FIG. 4 accordingly shows a representative placement of the disclosed scaling operation within an otherwise conventional SCF workflow.

FIG. 5 is a representative convergence and benchmark evaluation view for unscaled and scaled solver operation. In representative embodiments, FIG. 5 illustrates comparative convergence behavior, benchmark material processing, reference-data comparison, and generation of error or report outputs. FIG. 5 is intended to convey representative evaluation workflows and outcomes rather than to limit the invention to any particular benchmark set, metric, or plotting format.

FIG. 6 is a host-code integration view showing representative insertion points for multiple solver platforms. In representative embodiments, FIG. 6 illustrates how the disclosed correction may be implemented as a patch, linked library, plugin, injector, or equivalent software component in host environments such as VASP, Quantum ESPRESSO, BerkeleyGW, or related codes. FIG. 6 further shows that core solver infrastructure may remain unchanged in representative implementations while the disclosed scaling operation is inserted at selected computational locations.

FIG. 7 is a GW extension view showing scaling of screened interaction and related quantities. In representative embodiments, FIG. 7 illustrates application of the disclosed parameter-free correction to screened interaction, inverse dielectric representation, self-energy quantities, or related GW operators in one-shot or self-consistent quasiparticle workflows. FIG. 7 therefore shows that the disclosed correction framework is not limited to Kohn-Sham exchange-correlation kernels alone.

FIG. 8 is a computing and deployment architecture view for executing the disclosed methods. In representative embodiments, FIG. 8 illustrates processor, accelerator, memory, storage, solver, scaling, validation, networking, cloud, cluster, and downstream interface components usable to execute the disclosed workflows. FIG. 8 also represents exemplary deployment contexts including local workstations, GPU-enabled systems, clusters, cloud services, and downstream computational pipelines.

### DETAILED DESCRIPTION OF THE INVENTION

The following detailed description sets forth illustrative embodiments of the disclosed recognition-enhanced electronic-structure solver technology with reference to the accompanying drawings. The drawings and associated reference numerals are provided to illustrate representative structures, workflows, modules, and data relationships and are not intended to limit the invention to the precise arrangements shown. Rather, the disclosed subject matter encompasses the described embodiments, modifications thereof, equivalents thereof, and combinations thereof, as permitted by the claims and supported by the present specification. As used herein, Recognition Science, also referred to as the Recognition Physics framework, provides an upstream parameter-free derivation pathway for a correction factor employed in the presently disclosed electronic-structure solver embodiments. The present application is directed to the application of that correction factor in electronic-structure calculation environments, including density-functional theory, hybrid density-functional theory, and GW-based workflows, and is not intended to claim every aspect of the broader Recognition Science framework. Accordingly, the discussion of upstream derivation below is limited to the portions needed to explain how the disclosed solver correction is obtained, applied, and used in a computational setting.

Unless the context clearly indicates otherwise, the term “host solver” refers to an electronic-structure code, engine, executable, library set, or computational workflow configured to perform one or more electronic-structure calculations. The term “exchange kernel” refers to an exchange-related quantity, operator, array, matrix, potential contribution, or functional component used in constructing an exchange or exchange-correlation contribution within a solver. The term “correlation kernel” refers to a correlation-related quantity, operator, array, matrix, potential contribution, or functional component used in constructing a correlation or exchange-correlation contribution within a solver. The term “exchange-correlation kernel” or “XC kernel” refers to one or more exchange-related and correlation-related quantities considered individually or in combination. The term “reciprocal-space array” refers to an indexed collection of values represented over reciprocal-lattice vectors, reciprocal-space grid points, plane-wave coefficients, momentum-space coordinates, or equivalent transformed coordinates. The term “self-consistent-field loop” or “SCF loop” refers to an iterative workflow in which one or more electronic quantities are repeatedly updated until a convergence condition is satisfied. The term “GW screening operator” refers to a screened interaction, dielectric-related quantity, inverse dielectric quantity, or related screening representation used in a GW workflow. The term “self-energy” refers to a quasiparticle correction operator or quantity, including a GW self-energy or related approximation thereof. The term “band structure” refers to one or more energy-versus-wave-vector relationships or analogous electronic dispersion outputs, and the term “band gap” refers to an energy separation between occupied and unoccupied electronic states, whether direct, indirect, quasiparticle-derived, optically inferred, or otherwise defined by the computational context. The term “delta_loop” refers to the correction parameter derived as described herein, and the term “lambda_loop” refers to a loop multiplier computed from lambda_loop=1−delta_loop. As used herein, a “certified constant source” includes, without limitation, a datastore, ledger, service, or repository configured to provide one or more values along with an associated validation artifact such as a signature, checksum, certificate, audit record, or other provenance indicator.

As used herein, an “exchange-related quantity” and a “correlation-related quantity” each include, without limitation, an exchange or correlation kernel array, an exchange-correlation potential contribution, an exchange or correlation operator term used in Hamiltonian construction, or an exchange/correlation contribution used in screening or self-energy evaluation, whether represented in reciprocal space, real space, or another solver representation.

In the disclosed embodiments, the correction is derived without empirical material-by-material fitting. In particular implementations, the upstream derivation may be expressed using the following plain-text relations:

phi=(1+sqrt(5))/2

X_opt=phi/pi

R_RP=7/12

delta_loop=X_opt\hat{ }(1+R_RP)lambda_loop=1−delta_loop

In certain embodiments, the upstream derivation may additionally be associated with the Recognition Composition Law and a corresponding cost functional, for example:

J(xy)+J(x/y)=2*J(x)*J(y)+2*J(x)+2*J(y)

J(x)=0.5*(x+1/x)−1

For purposes of the present application, those relations provide a parameter-free derivation pathway for the correction factor used in the disclosed solver implementations. The presently claimed technology is directed to the computational use of the resulting correction in electronic-structure solvers, including application of lambda_loop to exchange and correlation quantities before the primary iterative solution begins.

Recognition Loop-Correction Definitions (Non-Limiting). In some embodiments, the loop correction used herein is defined using a ratio-based normalization value and a fixed recognition exponent that together yield a deterministic, parameter-free multiplier usable for pre-first-iteration scaling of solver quantities. The following definitions are provided for clarity and to support deterministic implementation, and are not intended to limit the disclosed embodiments to a particular theoretical interpretation.

Definition of X_opt (Non-Limiting). In some embodiments, X_opt is defined as a dimensionless normalization ratio given by X_opt=phi/pi, where phi=(1+sqrt(5))/2 and pi is the circle constant. In such embodiments, X_opt is used as an input to computing the loop correction parameter, and may be computed directly at runtime, retrieved from a stored constant table, or obtained from a certified constant source as described herein.

Definition of R_RP (Non-Limiting). In some embodiments, R_RP is defined as a fixed recognition exponent used in computing the loop correction parameter. In representative implementations described herein, R_RP=7/12. In such embodiments, R_RP may be represented as a rational constant, a floating-point constant, or an equivalent encoded constant, and may be stored, retrieved, validated, or audited using a provenance store or a certified constant source.

Definition of delta_loop and lambda_loop (Non-Limiting). In some embodiments, the loop correction parameter is computed as delta_loop=X_opt\hat{ }(1+R_RP) and the loop multiplier is computed as lambda_loop=1−delta_loop. In representative implementations, delta_loop and lambda_loop are computed once per job, once per run, or once per solver initialization stage, and the resulting lambda_loop value is then applied prior to the first self-consistent-field iteration to scale one or more exchange-related and correlation-related quantities as described herein. In alternative embodiments, equivalent computational forms may be used that yield the same deterministic values for delta_loop and lambda_loop for the same inputs.

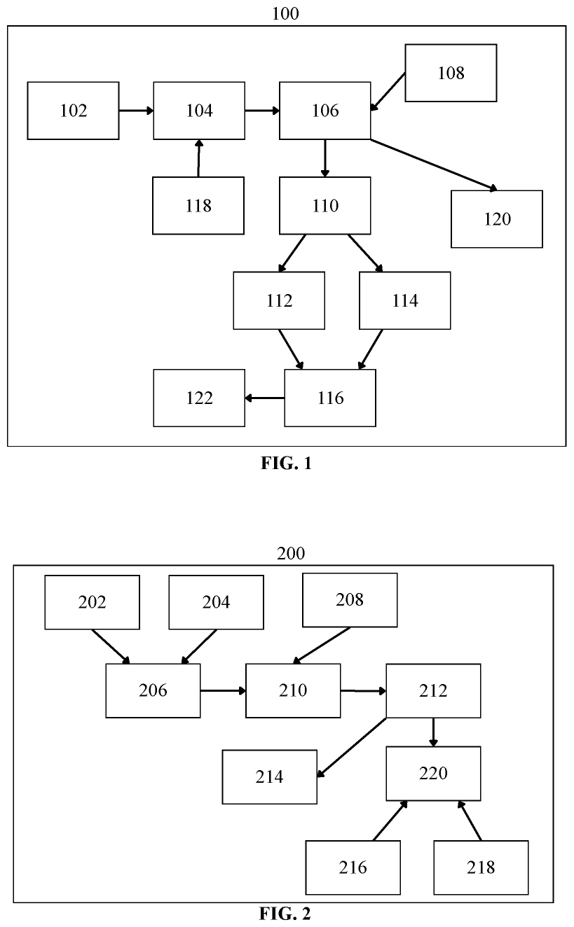

With reference now to FIG. 1, a recognition-enhanced electronic-structure solver environment 100 may include a structure input 102, a host electronic-structure solver 104, a Recognition Science correction engine 106, a correction-parameter derivation module 108, a kernel pre-scaler 110, a self-consistent-field engine 112, an optional GW engine 114, a result generator 116, a user interface 118, a provenance or verification interface 120, and an output datastore 122. In representative embodiments, the structure input 102 receives one or more atomic structures, molecular structures, crystal structures, supercells, basis selections, pseudopotential selections, convergence thresholds, job-control parameters, requested output properties, or combinations thereof. The host electronic-structure solver 104 may be a DFT solver, a hybrid DFT solver, a GW solver, a combined workflow, or another solver architecture configured to compute one or more electronic-structure properties. The Recognition Science correction engine 106 cooperates with the correction-parameter derivation module 108 to compute delta_loop and lambda_loop, either once per job, once per run, once per initialization stage, or at another suitable deterministic evaluation point. The kernel pre-scaler 110 then applies the disclosed scaling operation before the self-consistent-field engine 112 begins the principal iterative loop. In embodiments that include quasiparticle correction or many-body perturbation calculations, the optional GW engine 114 may further use the same parameter-free correction in screening-related or self-energy-related workflows. The result generator 116 may output band structures, band gaps, densities of states, charge densities, total energies, quasiparticle energies, screening properties, convergence data, benchmark metrics, or other calculated properties. The user interface 118 may provide configuration, execution, monitoring, and reporting functionality. The provenance or verification interface 120 may provide optional access to theorem-verification assets, certified-constant stores, audit records, or deterministic execution records. The output datastore 122 may store one or more generated outputs, intermediate values, logs, provenance records, benchmark results, model artifacts, or downstream-consumption files.

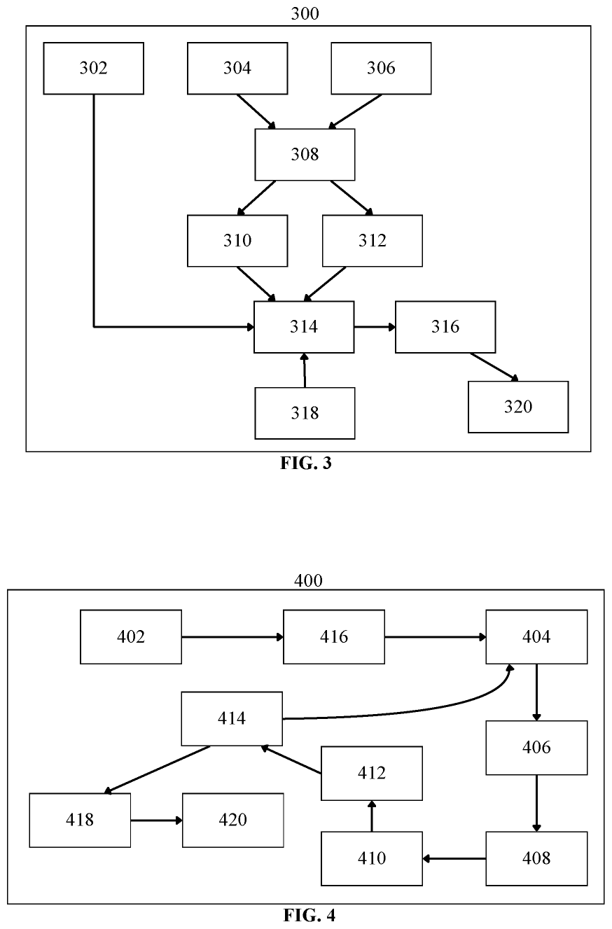

With reference next to FIG. 2, a correction-parameter derivation and certification workflow 200 may include a phi evaluator 202, a pi source 204, an X_opt calculator 206, an R_RP store 208, a delta_loop calculator 210, a lambda_loop calculator 212, a cache or register 214, an optional certified constant ledger interface 216, an optional theorem or proof interface 218, and a scaling-value output 220. In representative embodiments, the phi evaluator 202 computes or retrieves phi, the pi source 204 computes or retrieves pi, and the X_opt calculator 206 computes X_opt=phi/pi. The R_RP store 208 provides R_RP, which in representative embodiments is 7/12. The delta_loop calculator 210 then computes delta_loop=X_opt\hat{ }(1+R_RP), and the lambda_loop calculator 212 computes lambda_loop=1−delta_loop. The cache or register 214 may store one or both values for later use during solver initialization. In optional embodiments, the certified constant ledger interface 216 may retrieve, verify, or cross-check one or more constants or derived values against an auditable source, and the theorem or proof interface 218 may provide a machine-verification, formal-proof, or validation pathway associated with one or more derivation steps. The scaling-value output 220 provides lambda_loop to a subsequent solver stage, including the kernel pre-scaler 110 of FIG. 1 and the scaling architecture described with respect to FIG. 3. In representative embodiments, this workflow is deterministic in the sense that the same inputs yield the same derived output and the correction is not based on a fitted material-dependent mixing coefficient.

With reference next to FIG. 3, a reciprocal-space exchange-correlation kernel scaling architecture 300 may include a reciprocal-space density array 302, an exchange kernel array 304, a correlation kernel array 306, a scaling operator 308, a scaled exchange kernel array 310, a scaled correlation kernel array 312, an exchange-correlation contribution assembler 314, a Hamiltonian or potential constructor 316, a reciprocal-lattice vector index set 318, and a pre-SCF initialization stage 320. In representative embodiments, the reciprocal-space density array 302 contains density values, coefficients, transforms, or related quantities indexed over reciprocal-space coordinates, plane-wave basis terms, reciprocal-lattice vectors, momentum coordinates, or equivalent transformed representations. The exchange kernel array 304 and correlation kernel array 306 respectively store exchange-related and correlation-related quantities used by the host solver in assembling an exchange-correlation contribution for a Hamiltonian, potential, effective operator, or analogous computational object. The scaling operator 308 applies the disclosed parameter-free multiplier lambda_loop to the exchange kernel array 304 and the correlation kernel array 306 to produce the scaled exchange kernel array 310 and the scaled correlation kernel array 312. In representative embodiments, the scaling occurs during the pre-SCF initialization stage 320 before the first self-consistent iteration begins, and the scaled arrays are then passed to the exchange-correlation contribution assembler 314 and the Hamiltonian or potential constructor 316 for use over the reciprocal-lattice vector index set 318. In particular implementations, the exchange-correlation contribution may be expressed in plain-text form as E_xc=sum over G of ([Kx(G)+Kc(G)]*rho(G)), and the disclosed scaling may be expressed as Kx′(G)=Kx(G)*lambda_loop and Kc′(G)=Kc(G)*lambda_loop. In representative software implementations, the scaling may be performed as an in-place array operation, a vector-scaling call, a BLAS call, or an equivalent in-memory transformation, for example DSCAL(N, lambda_loop, Kx_array, 1) and DSCAL(N, lambda_loop, Kc_array, 1), where N denotes the number of indexed elements to be scaled. The presently disclosed embodiments most strongly support a one-time pre-first-iteration scaling operation, after which the self-consistent solver proceeds without repeated rescaling during subsequent iterations unless a narrower alternative embodiment expressly provides otherwise.

With reference next to FIG. 4, a self-consistent-field workflow 400 may include an initial density 402, a Hamiltonian builder 404, a diagonalizer 406, a wavefunction output 408, an updated density 410, a density mixer 412, a convergence evaluator 414, a scaled-kernel injection stage 416, a converged solution 418, and a property output 420. In representative embodiments, the initial density 402 may be a guessed density, a restarted density, a projected density, a superposed atomic density, or another initial state suitable for a self-consistent electronic-structure workflow. The scaled-kernel injection stage 416 is positioned before the principal iterative loop so that the corrected exchange-correlation representation is established before the Hamiltonian builder 404 first constructs an iterative Hamiltonian or analogous operator. Once the corrected representation is in place, the Hamiltonian builder 404 constructs an operator based on the current density or state, the diagonalizer 406 computes eigenvalues, eigenvectors, wavefunctions, orbitals, or related solver outputs, and the wavefunction output 408 is used to compute the updated density 410. The density mixer 412 then forms a new mixed density using, for example, Pulay mixing, Broyden mixing, linear mixing, or another mixing process, and the convergence evaluator 414 determines whether a convergence condition has been met. In some embodiments, the convergence evaluator determines convergence when at least one of: (i) an energy-change metric satisfies |E_new−E_old|≤1×10\hat{ }−6 eV, (ii) a density residual satisfies ∥ρ′−ρ∥≤1×10\hat{ }−5 in solver units, or (iii) both conditions are satisfied, after which the workflow outputs the converged solution 418 and one or more properties through property output 420. If convergence has not been reached, the workflow iterates until the converged solution 418 is obtained and the property output 420 is generated. In representative embodiments, positioning the scaled-kernel injection stage 416 before iterative execution reduces effective loop gain, reduces initial residual magnitude, reduces oscillatory behavior, improves conditioning of the density-mixing stage, and reduces the number of iterations needed for convergence in representative benchmarks. These effects are described as representative consequences of the disclosed preconditioning approach and are not intended to require that every solver configuration exhibit identical numerical behavior.

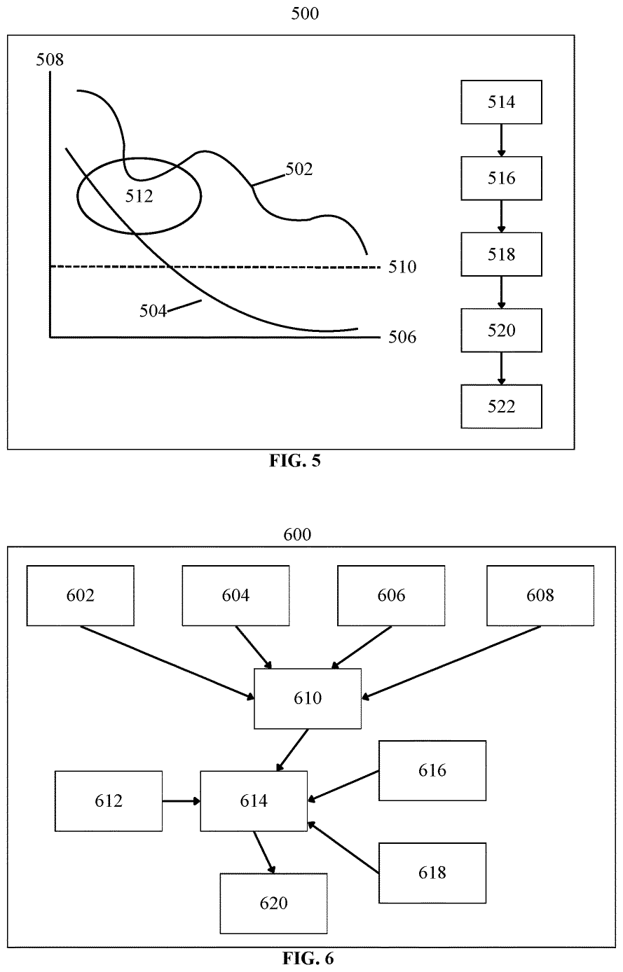

With reference next to FIG. 5, a representative convergence and benchmark evaluation workflow 500 may include an unscaled solver branch 502, a scaled solver branch 504, an iteration axis 506, a residual, energy-change, or error axis 508, a convergence threshold 510, an oscillation region 512, a benchmark material set 514, an experimental reference dataset 516, an error calculator 518, a report generator 520, and a benchmark result store 522. In representative embodiments, the evaluation workflow 500 is used to compare solver performance with and without application of the disclosed parameter-free correction. The unscaled solver branch 502 may execute a baseline solver workflow using unmodified exchange-correlation quantities, while the scaled solver branch 504 may execute an otherwise comparable workflow using the disclosed pre-first-iteration correction. The iteration axis 506 and the residual, energy-change, or error axis 508 provide a representative plotting framework for comparing convergence traces, convergence speed, oscillatory behavior, or error progression relative to the convergence threshold 510. The oscillation region 512 may represent portions of a convergence trace in which an unscaled workflow exhibits slower stabilization or greater oscillatory behavior than a scaled workflow. The benchmark material set 514 may include representative semiconductors, oxides, chalcogenides, halides, or other materials used to assess solver performance, and the experimental reference dataset 516 may include one or more experimentally determined band gaps, quasiparticle energies, or other reference properties. The error calculator 518 may compute mean absolute error, maximum error, signed error, classification error, convergence count, runtime statistics, or related metrics. The report generator 520 may generate tables, plots, logs, or summary files for review, and the benchmark result store 522 may store material-by-material results, aggregate metrics, or related evaluation outputs. In representative embodiments disclosed herein, benchmark comparisons indicate reduced iteration counts, reduced wall time, and reduced error relative to experiment, but such benchmark outcomes are presented as representative implementations and not as absolute limitations on the scope of the invention.

With reference next to FIG. 6, a representative host-code integration architecture 600 may include a VASP insertion point 602, a Quantum ESPRESSO insertion point 604, a BerkeleyGW insertion point 606, a compute_delta_loop library 608, a scaling call interface 610, unchanged solver libraries block 612, a host executable 614, an optional plugin or injector 616, an optional GPU execution path 618, and a patch repository 620. In representative embodiments, the host-code integration architecture 600 illustrates how the disclosed correction can be incorporated into multiple solver platforms without redesigning the entire electronic-structure codebase. The compute_delta_loop library 608 may include a compact function, routine, or code unit configured to compute phi, X_opt, R_RP, delta_loop, and lambda_loop, either by direct evaluation, by retrieval from a verified source, or by a combination thereof. The scaling call interface 610 may provide one or more vector-scaling or array-scaling operations that apply lambda_loop to target solver quantities at one or more selected insertion points. The unchanged solver libraries block 612 represents FFT libraries, diagonalization routines, mixing routines, pseudopotential input/output components, linear-response components, or other infrastructure that may remain unmodified in representative implementations. The host executable 614 may call the correction logic directly, while the optional plugin or injector 616 may provide an alternate delivery mechanism that integrates the disclosed correction as a linked module, loadable extension, wrapper, source patch, binary patch, or other software adjunct. The optional GPU execution path 618 represents implementations in which the host workflow executes on accelerator-equipped systems. The patch repository 620 may store source modifications, plugin packages, injector instructions, deployment bundles, validation artifacts, or versioned integration files. In representative embodiments, the VASP insertion point 602 may be positioned after computation of exchange-correlation kernel quantities and before the primary SCF loop; the Quantum ESPRESSO insertion point 604 may be positioned after exchange-correlation potential construction and before iterative SCF execution; and the BerkeleyGW insertion point 606 may be positioned at a self-energy or related GW quantity that is to be scaled in accordance with the disclosed correction. Equivalent host-code embodiments may be used in other solver environments so long as the disclosed scaling is applied to an appropriate exchange-correlation, screening, or self-energy related quantity within the scope of the present disclosure.

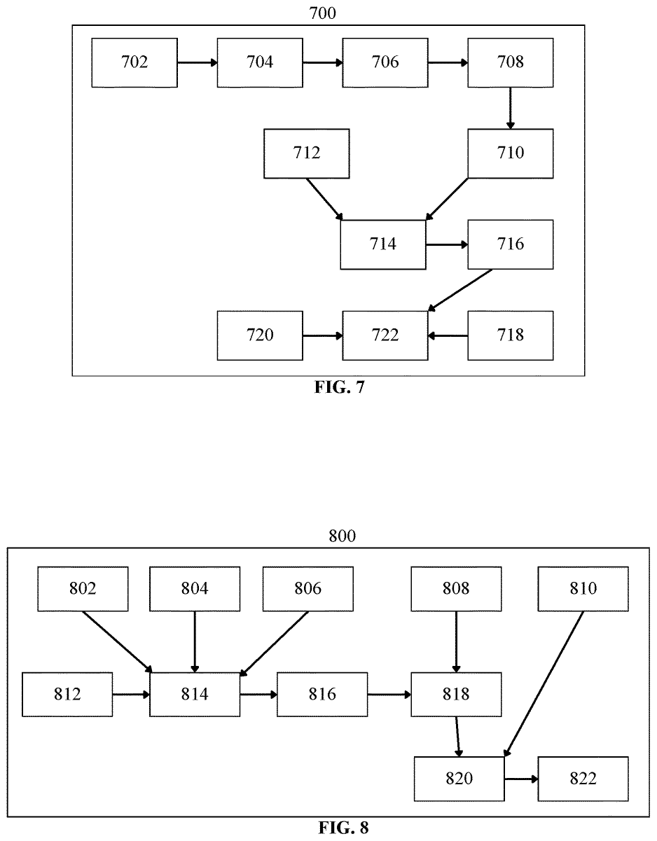

With reference next to FIG. 7, a GW extension architecture 700 may include a bare Coulomb interaction input 702, a dielectric-function evaluator 704, an inverse dielectric representation 706, a screened interaction 708, a scaled screened interaction 710, a Green's function 712, a self-energy 714, a scaled self-energy 716, a one-shot GW branch 718, a self-consistent GW branch 720, and a quasiparticle output 722. In representative embodiments, the GW extension architecture 700 illustrates that the disclosed parameter-free correction is not limited to exchange-correlation kernels in a Kohn-Sham loop and may also be applied to one or more GW-related quantities. The dielectric-function evaluator 704 and inverse dielectric representation 706 may generate screening-related quantities from which the screened interaction 708 is formed. In representative embodiments, the disclosed correction may be applied to the screened interaction according to W′(q, omega)=W(q, omega)*lambda_loop, or to an inverse dielectric representation according to epsilon_inv′(q, omega)=epsilon_inv(q, omega)*lambda_loop. The scaled screened interaction 710 may then be combined with the Green's function 712 to form a corrected self-energy workflow. In some embodiments, the self-energy 714 itself may be scaled or otherwise modified to produce the scaled self-energy 716. The one-shot GW branch 718 may represent a G0W0-type workflow in which the correction is applied in a non-iterative or single-pass manner, whereas the self-consistent GW branch 720 may represent workflows in which a screened interaction, dielectric-related quantity, or self-energy-related quantity is iteratively updated. The quasiparticle output 722 may include one or more corrected band structures, band gaps, quasiparticle energies, dispersions, or related properties. In representative embodiments, application of the disclosed correction in a GW setting may improve starting-point quality, reduce overscreening, reduce self-consistent iteration count, improve quasiparticle predictions, or combinations thereof, while still remaining parameter-free and deterministic.

With reference next to FIG. 8, a computing and deployment architecture 800 may include a processor 802, a GPU or accelerator 804, a memory 806, a storage 808, a network interface 810, an instructions store 812, a solver module 814, a scaling module 816, a benchmark or validation module 818, a cloud or cluster execution interface 820, and a downstream output interface 822. In representative embodiments, the processor 802 executes one or more software components that implement the host solver and the disclosed correction logic, while the GPU or accelerator 804 may accelerate FFT operations, diagonalization, matrix operations, screening calculations, or related compute-intensive tasks. The memory 806 and storage 808 may store structure inputs, pseudopotentials, basis data, kernel arrays, self-energy arrays, benchmark datasets, result files, software patches, plugins, logs, provenance artifacts, and other data used by the disclosed workflows. The network interface 810 may support local-network, cluster, remote-service, or cloud communications. The instructions store 812 may contain executable instructions for computing the correction parameter, applying the scaling operation, running solver jobs, and generating results. The solver module 814 may implement a DFT, hybrid DFT, GW, or related workflow; the scaling module 816 may implement one or more embodiments of delta_loop and lambda_loop computation and associated scaling operations; and the benchmark or validation module 818 may execute comparison workflows, generate error metrics, or store validation results. The cloud or cluster execution interface 820 may support execution on a workstation, cluster node, GPU-enabled server, cloud instance, or distributed pipeline, including high-throughput materials-screening workflows and service-based deployments. The downstream output interface 822 may export band gaps, band structures, densities of states, quasiparticle properties, material rankings, model-training data, simulation-ready files, or other outputs to downstream workflows, including machine-learning pipelines, materials databases, cloud services, and semiconductor-device modeling tools. Thus, FIG. 8 illustrates that the disclosed technology may be embodied not only as a local solver modification but also as a deployable computational platform for broader scientific and engineering use.

In some embodiments, the disclosed correction may be implemented in plane-wave codes, reciprocal-space codes, real-space codes, all-electron codes, hybrid DFT solvers, GW solvers, or other computational platforms that use exchange-related, correlation-related, screening-related, or self-energy-related quantities that can be deterministically modified before or during an iterative solution process. In certain embodiments, the disclosed correction may be implemented as a source-level patch, a dynamically loaded module, a linked library, a wrapper, an injector, a compiled extension, or another software delivery mechanism. In further embodiments, the disclosed technology may be used in high-throughput screening, battery-material discovery, OLED or optoelectronic design, semiconductor device simulation, machine-learning force-field generation, cloud-based materials simulation, or related computational environments in which improved convergence behavior and improved electronic-property prediction are technically beneficial. These embodiments are illustrative and not limiting.

Where numerical results, iteration counts, runtimes, or error values are described herein as representative examples, such results may depend on solver configuration choices including, for example, basis selection, cutoff values, pseudopotential selection, k-point sampling, convergence thresholds, and mixing settings. Unless expressly stated as a requirement of a claim, such numerical results are provided as illustrative embodiments and representative implementations and are not intended as absolute guarantees for every solver configuration or material system. The following worked examples are provided to illustrate representative implementations of the disclosed technology and to show how the parameter-free correction may be applied in different solver environments. These examples are intended to support enablement and to demonstrate representative performance and accuracy characteristics of disclosed embodiments. The examples are not intended to limit the scope of the invention to any particular material, solver configuration, benchmark set, runtime environment, or numerical outcome.

### Example 1—Silicon/VASP

In one representative example, the disclosed correction is applied to a silicon calculation executed in a VASP-based workflow. The system setup may include a silicon structure, such as a supercell or periodic crystalline silicon model, together with a plane-wave basis, a pseudopotential or projector-augmented-wave input, and a hybrid density-functional workflow. In a representative implementation, the host solver is VASP and the disclosed correction is introduced after exchange-correlation kernel computation and before commencement of the principal self-consistent-field loop. In such an implementation, delta_loop is computed according to delta_loop=X_opt\hat{ }(1+R_RP), lambda_loop is computed according to lambda_loop=1−delta_loop, and the exchange and correlation quantities are scaled prior to the first self-consistent iteration. In an unscaled representative run, the calculated band gap may be approximately 1.82 eV and the solver may converge in approximately 14 self-consistent iterations, with a representative runtime of approximately 42 minutes on an accelerator-enabled system. In a corresponding representative scaled run, the calculated band gap may be approximately 1.18 eV and convergence may occur in approximately 5 iterations, with a representative runtime of approximately 22 minutes. Relative to an experimental band gap of approximately 1.17 eV, the representative scaled result may exhibit an error of approximately +10 meV. These values are presented as representative benchmark results for a disclosed embodiment and are not intended as universal guarantees.

### Example 2—GaAs/Quantum ESPRESSO

In another representative example, the disclosed correction is applied to a gallium arsenide calculation in a Quantum ESPRESSO workflow. The system setup may include a GaAs unit cell or periodic structure, norm-conserving or other suitable pseudopotentials, and a hybrid or related electronic-structure workflow in which exchange-correlation quantities are available for deterministic pre-scaling. In a representative implementation, the host solver is Quantum ESPRESSO and the disclosed correction is inserted after exchange-correlation potential generation and before iterative self-consistent execution. In an unscaled representative calculation, the computed band gap may be approximately 1.98 eV and convergence may occur in approximately 16 iterations. In a corresponding representative scaled calculation, the computed band gap may be approximately 1.53 eV and convergence may occur in approximately 6 iterations. Relative to an experimental value of approximately 1.52 eV, the scaled result may exhibit an error of approximately +10 meV. This example illustrates that the disclosed parameter-free correction can be integrated into a host solver distinct from the VASP example while still producing representative improvements in convergence behavior and band-gap prediction.

### Example 3—MoS2/BerkeleyGW

In a further representative example, the disclosed correction is applied in a BerkeleyGW-based workflow for a molybdenum disulfide system, such as a monolayer MoS2 model. The system setup may include a GW workflow based on a selected starting point, such as a PBE0 or related electronic-structure input, followed by quasiparticle correction. In a representative unscaled GW calculation, a computed band gap may be approximately 2.45 eV and the workflow may require approximately 18 self-consistent GW iterations. In a corresponding representative scaled calculation, the disclosed correction may be applied to a screening-related quantity, a self-energy-related quantity, or both, and the resulting band gap may be approximately 1.89 eV with convergence in approximately 6 iterations. Relative to an experimental photoluminescence or related reference value of approximately 1.90 eV, the representative scaled result may exhibit an error of approximately −10 meV. This example shows that the disclosed correction framework can be extended beyond Kohn-Sham exchange-correlation scaling and applied in a quasiparticle-correction context involving screening and self-energy quantities.

### Example 4—High-Throughput Battery Screening

In another representative example, the disclosed correction is used in a high-throughput screening workflow for candidate battery materials. The system setup may include a computational pipeline configured to evaluate a large set of candidate cathode or related materials, for example on the order of hundreds or thousands of structures, using a host solver configured with the disclosed parameter-free correction. In one representative implementation, a VASP-based workflow executing on a cluster or GPU-enabled compute environment processes approximately 1000 candidate materials. Using representative unscaled runtime assumptions of approximately 42 minutes per structure, the total runtime may be approximately 700 hours. Using corresponding representative scaled runtime assumptions of approximately 22 minutes per structure, the total runtime may be approximately 367 hours, representing a reduction of approximately 333 hours or approximately 47.5 percent. In representative embodiments, the resulting corrected outputs may then be used to classify candidate materials according to band-gap criteria, such as metallic, semiconducting, or insulating behavior, for downstream prioritization. This example illustrates the technical value of reduced iteration count and reduced wall time in a deployment context where throughput is material to the usefulness of the solver.

### Example 5—OLED/TADF Emitter Design

In another representative example, the disclosed correction is applied in a workflow for evaluating an organic semiconductor or thermally activated delayed fluorescence emitter. The system setup may include a molecular or periodic model of an emitter candidate, such as 4CzIPN or another TADF-active system, together with a solver workflow capable of computing a singlet-triplet energy difference or related optical quantity. In a representative embodiment, the disclosed parameter-free scaling is applied before iterative solution and the resulting corrected calculation yields a singlet-triplet gap DeltaEST of approximately 0.08 eV. Relative to an experimental value of approximately 0.08 eV, for example within an uncertainty band of approximately +/−0.01 eV, the corrected result may correctly identify the molecule as a TADF-active candidate. This example illustrates that the disclosed correction may be used not only for bulk band-gap prediction but also for molecular or optical-property workflows in which small energy differences are relevant to material selection and design.

### Example 6—TiO2 Method Comparison

In a further representative example, the disclosed correction is evaluated for rutile TiO2 in a comparative solver study. The system setup may include a TiO2 crystal structure, an appropriate basis or pseudopotential selection, and a set of comparative workflows including PBE, PBE0, HSE06, GW@PBE0, and RP-scaled PBE0. In a representative comparison, the experimental band gap may be approximately 3.03 eV. A representative PBE calculation may yield approximately 1.73 eV, corresponding to an error of approximately −1300 meV, and may converge in approximately 8 cycles. A representative PBE0 calculation may yield approximately 3.75 eV, corresponding to an error of approximately +720 meV, and may converge in approximately 17 cycles. A representative HSE06 calculation may yield approximately 3.38 eV, corresponding to an error of approximately +350 meV, and may converge in approximately 12 cycles. A representative GW@PBE0 calculation may yield approximately 3.10 eV, corresponding to an error of approximately +70 meV, and may converge in approximately 18 cycles. A representative RP-scaled PBE0 calculation may yield approximately 3.05 eV, corresponding to an error of approximately +20 meV, and may converge in approximately 4 cycles. This example illustrates that, in representative disclosed implementations, the parameter-free pre-scaling technique can simultaneously provide improved convergence behavior and highly competitive agreement with experiment. The example is provided as a representative comparison and is not intended to require any specific material, runtime environment, or numerical threshold in every embodiment.

In the foregoing examples, specific materials, runtime values, iteration counts, and accuracy results are provided to illustrate representative disclosed embodiments and to show how the disclosed correction may be implemented and evaluated in practice. One of ordinary skill in the art, having the benefit of the present disclosure, will understand that the same underlying parameter-free correction framework may be applied to other materials, solvers, hardware environments, basis sets, pseudopotentials, workflow structures, and deployment contexts without departing from the scope of the invention.

The disclosed technology is not limited to the particular solver environments, data structures, or computational workflows expressly described above. Rather, the presently disclosed parameter-free correction framework may be implemented in a variety of electronic-structure and related computational environments so long as a recognition-derived correction factor is computed and used to scale one or more exchange-related, correlation-related, screening-related, self-energy-related, or analogous quantities in a deterministic manner consistent with the present disclosure. The following embodiments and variations are provided to further illustrate the breadth of the disclosed subject matter and to support implementation in multiple technical contexts.

In some embodiments, the disclosed correction may be implemented in all-electron codes rather than in pseudopotential-based plane-wave codes. In such embodiments, the corrected quantity need not be a reciprocal-space exchange kernel array as described above, but may instead be a real-space exchange-correlation potential, an all-electron exchange-related quantity, a correlation-related quantity, an augmentation-region contribution, or another solver quantity that contributes to formation of an effective Hamiltonian, potential, or analogous operator. In representative all-electron implementations, the same deterministic derivation of delta_loop and lambda_loop may be used, while the actual scaling operation is applied to a real-space potential representation or another all-electron data representation rather than a plane-wave reciprocal-space array. Accordingly, the disclosed invention is not limited to reciprocal-space kernel scaling, but also encompasses real-space and all-electron implementations that use the same parameter-free correction logic.

In additional embodiments, the disclosed correction may be applied in time-dependent density-functional theory workflows. In such embodiments, a time-dependent exchange-correlation kernel, response kernel, frequency-dependent response quantity, or related operator may be scaled using lambda_loop before or during a time-dependent or response-theory calculation. In representative implementations, the disclosed correction may improve computed optical absorption spectra, excitonic-property estimates, response-function convergence, or related optical and excited-state calculations. Such embodiments may be useful in applications involving OLED materials, solar-cell absorbers, excitonic semiconductors, organic emitters, photonic materials, or other systems in which time-dependent or response-theory calculations are performed. The present disclosure therefore contemplates application of the same parameter-free correction framework to static and dynamic electronic-structure workflows alike, provided that the correction is used in a manner supported by the solver architecture and disclosed herein. In further embodiments, the disclosed correction may be used in quantum Monte Carlo workflows. In such embodiments, the correction need not be limited to a DFT exchange-correlation kernel or a GW screening quantity, but may instead be applied to a Jastrow-related quantity, a trial-wavefunction-related term, a variance-reduction quantity, or another QMC-related quantity that influences iterative solution or estimator behavior. In representative implementations, use of the disclosed correction may reduce variance, improve convergence toward a fixed-node energy, improve numerical conditioning, or otherwise enhance the efficiency of a QMC workflow. While QMC implementations may use data structures and solver architectures different from DFT and GW codes, they may nevertheless employ the same parameter-free correction logic and deterministic derivation pathway described herein.

In some embodiments, the disclosed correction may be embodied in a software architecture that is distinct from a direct source-level patch. For example, the correction may be implemented as a dynamically linked library, a statically linked library, a runtime wrapper, a plugin, a compiler-assisted transformation, an injector, a binary-rewrite mechanism, a job-preprocessing stage, a simulation-orchestration layer, a cloud microservice, a containerized service component, or another software delivery mechanism. In such embodiments, the host electronic-structure code may remain substantially unchanged, while the disclosed correction is inserted through a configuration layer, a runtime interface, a dispatch mechanism, an intermediate representation, or another integration path. The present invention is therefore not limited to a particular code-modification technique, provided that the disclosed parameter-free correction is computed and applied in a manner consistent with the present specification.

In some embodiments, the disclosed correction may be used in machine-learning workflows. For example, corrected electronic-structure outputs generated using the disclosed parameter-free scaling may be used as reference data for training machine-learning interatomic potentials, machine-learning force fields, surrogate property predictors, band-gap classifiers, materials-ranking models, or other data-driven computational tools. In such embodiments, the machine-learning model need not explicitly compute delta_loop or lambda_loop during inference, but may instead inherit improved accuracy or improved property fidelity through training on reference data produced by a solver implementing the disclosed correction. Accordingly, the present disclosure encompasses workflows in which the disclosed correction is used directly in a solver as well as workflows in which the corrected solver output serves as training or calibration data for a downstream computational model.

In further embodiments, the disclosed correction may be used in high-throughput screening systems, materials databases, cloud simulation services, and semiconductor design environments. In representative deployments, a user may submit a crystal structure, molecular structure, or materials dataset to a cloud-based or cluster-based workflow that applies the disclosed parameter-free correction and returns one or more computed properties such as band gap, band structure, density of states, total energy, screening quantity, or quasiparticle output. In other representative deployments, corrected outputs may be exported into semiconductor-device simulators, technology computer-aided design environments, compact-model generation pipelines, or electronic design automation tools in order to improve device-level simulation using more accurate electronic-property inputs. Thus, the present invention is not limited to standalone academic solver execution, but also encompasses service-based, industrial, and production-scale deployment architectures.

In some embodiments, the disclosed correction may be used together with one or more optional provenance or formal-verification components. For example, the correction factor may be computed directly from the disclosed equations at runtime, retrieved from a certified store, cross-checked against an auditable constant repository, validated against a theorem-verification interface, or logged in a runtime attestation record. In such embodiments, formal-verification or provenance components may provide additional confidence, traceability, reproducibility, or commercial deployment value, but are not required in all embodiments unless expressly recited in a claim. The present application therefore discloses provenance-enhanced and formally supported implementations without making such support mandatory for every practice of the invention.

In all such embodiments, the disclosed correction remains parameter-free in the sense that the scaling factor is derived from the disclosed upstream relations rather than fitted on a material-by-material basis. Likewise, in representative embodiments, the correction remains deterministic in the sense that the same derivation path produces the same correction factor for the same inputs. However, the specific host solver, data representation, insertion point, runtime environment, deployment mode, benchmark metric, and downstream use case may vary while still falling within the scope of the present disclosure. The foregoing embodiments and variations are therefore illustrative and are not intended to limit the invention except as set forth in the claims. The disclosed technology may be validated using one or more benchmark, transferability, runtime, and solver-comparison workflows designed to assess convergence behavior, computational efficiency, and property-prediction accuracy. Such validation workflows may be executed in connection with one or more host codes, benchmark material sets, and experimental reference datasets, and may be used to confirm that the disclosed parameter-free correction produces representative technical benefits when applied before iterative solver execution. These validation workflows are presented as illustrative verification procedures for disclosed embodiments and are not intended to limit the scope of the invention to any particular test protocol, benchmark composition, solver version, hardware platform, or acceptance threshold.

In some embodiments, a first validation workflow may comprise a silicon and gallium arsenide benchmark using a host code such as Quantum ESPRESSO, VASP, or another electronic-structure solver configured to permit implementation of the disclosed pre-first-iteration scaling. In a representative procedure, a first set of jobs is executed without the disclosed scaling and a second set of jobs is executed with the disclosed scaling, while holding other relevant solver settings substantially constant. Convergence behavior may then be compared by measuring one or more of self-consistent iteration count, residual magnitude, oscillatory behavior, total runtime, band-gap prediction, and error relative to experiment. In representative embodiments, the corrected workflows may converge in fewer iterations and may yield band-gap values closer to experiment than corresponding unscaled workflows.

In additional embodiments, a second validation workflow may comprise a multi-material benchmark set including semiconductors, insulators, oxides, chalcogenides, halides, or other representative compounds. In one representative implementation, a benchmark set may include approximately thirty compounds or another suitable number of materials selected to test transferability across multiple material classes. For each material, a host solver may be executed in an unscaled mode and a scaled mode, and one or more properties, including band gap, quasiparticle energy, total energy, density of states, or convergence metrics, may be compared to experimental or otherwise trusted reference values. Aggregate statistics such as mean absolute error, maximum error, signed error, classification accuracy, runtime reduction, or convergence-count reduction may then be computed. In representative disclosed embodiments, such a benchmark may be used to demonstrate that the same parameter-free correction factor can be applied across multiple materials without material-specific tuning.

In further embodiments, a third validation workflow may comprise a quasiparticle or photoluminescence cross-check using a GW-capable environment such as BerkeleyGW or another workflow configured to process screened interaction or self-energy quantities. For example, a monolayer molybdenum disulfide workflow may be executed with and without application of the disclosed correction to one or more GW-related quantities, and the resulting quasiparticle or photoluminescence-comparable gap may be compared to a reference value. Such a workflow may be used to assess whether the disclosed correction improves starting-point quality, reduces overscreening, reduces self-consistent iteration count, improves agreement with reference values, or combinations thereof. This validation pathway supports embodiments in which the correction extends beyond DFT exchange-correlation quantities and is also applied in GW workflows.

In some embodiments, a fourth validation workflow may comprise a runtime or accelerator benchmark. In such a workflow, a representative material system, such as a silicon supercell or another computationally nontrivial structure, may be executed on a GPU-enabled system, cluster, workstation, or cloud environment with and without the disclosed correction. Total runtime, per-iteration runtime, memory overhead, accelerator utilization, and throughput may then be measured. In representative disclosed embodiments, the corrected workflow may exhibit a wall-time reduction relative to an unscaled baseline due to reduced iteration count, while introducing little or no material additional memory burden beyond storage of the correction factor and scaled arrays. Such validation may be particularly useful for deployment-oriented embodiments involving high-throughput screening or cloud simulation services.

In still further embodiments, a fifth validation workflow may comprise a transferability study using materials not included in an initial benchmark set. In such a workflow, the same disclosed correction factor may be applied, without modification, to a set of additional materials chosen to test generality across different crystal classes, chemistries, band-gap ranges, dimensionalities, or solver environments. The resulting electronic-property outputs may be compared against experimental references or trusted computational references in order to confirm that the correction remains usable across multiple materials without empirical retuning. This type of validation is useful for supporting the presently disclosed parameter-free character of the correction mechanism and for distinguishing the disclosed approach from conventional material-specific parameter fitting.

In some embodiments, validation may also include deterministic verification or provenance verification. For example, one or more tests may confirm that repeated execution of the same correction-derivation workflow produces the same value of delta_loop and lambda_loop for the same inputs, that runtime-generated values match values retrieved from a certified source, or that scaled quantities are produced consistently across runs, platforms, or software versions. Additional validation may include theorem-oriented checks, numerical cross-checks, cached-value validation, or runtime attestation logging. Such procedures may be useful in regulated, enterprise, or audited deployment environments, although they are not required in every embodiment unless expressly recited in a claim.

The foregoing validation and verification workflows may be used individually or in combination. One of ordinary skill in the art, having the benefit of the present disclosure, will understand that the specific benchmark composition, runtime environment, threshold values, and comparison datasets may vary depending on the host solver, target material class, and deployment context. Accordingly, the disclosed invention is not limited to any single validation methodology, but rather encompasses the described parameter-free correction framework together with representative methods for confirming its operation, performance, accuracy, and reproducibility. The disclosed technology provides a number of technical advantages over conventional electronic-structure workflows that rely on empirically selected exchange-mixing parameters, repeated post hoc correction cycles, or computationally expensive quasiparticle refinement steps. In particular, the present disclosure provides a parameter-free correction framework in which a scaling factor is deterministically derived from the disclosed upstream relations and applied before the principal iterative solver loop begins. As a result, the disclosed embodiments can improve convergence behavior and property prediction without requiring material-by-material fitting of an empirical exchange fraction or analogous tuning parameter.

In some embodiments, one advantage of the disclosed technology is that it is parameter-free in the operative sense relevant to solver deployment. Rather than selecting a mixing coefficient through empirical calibration, human intuition, material-specific tuning, or dataset-driven fitting, the disclosed framework computes delta_loop and lambda_loop from the disclosed derivation pathway and applies the resulting correction deterministically. This can reduce the burden associated with selecting and validating separate tuning values for different materials or classes of materials, and can improve reproducibility across runs, users, code branches, and deployment environments.

In additional embodiments, a further advantage is improved convergence behavior. Because the disclosed correction is applied before the first self-consistent iteration, the solver begins from a corrected exchange-correlation representation rather than from an uncorrected representation that may require a larger iterative traversal through density space or quasiparticle-solver space. In representative benchmarks disclosed herein, this may manifest as reduced initial residuals, reduced oscillatory behavior, improved conditioning for density mixing, and a reduction in the number of iterations required to reach convergence. Such convergence improvements can be beneficial not only for single calculations but also for large-scale computational campaigns in which aggregate runtime is materially affected by per-job iteration count.

In further embodiments, the disclosed technology provides improved computational efficiency. Where a reduction in iteration count is realized, corresponding reductions in wall time may also be obtained, subject to fixed overhead associated with initialization, file input/output, job dispatch, and other non-iterative components. In representative implementations described herein, the disclosed correction may therefore provide a favorable balance between computational cost and output quality, particularly in hybrid DFT and GW environments that would otherwise require additional cycles or more expensive iterative refinement. This efficiency advantage may be especially valuable in high-throughput materials screening, cloud-based simulation, GPU-enabled workloads, and production-scale engineering pipelines.

In some embodiments, another advantage is improved electronic-property prediction relative to certain unscaled solver baselines. The disclosed examples describe representative situations in which the corrected workflow yields reduced error relative to experimental band-gap values or related reference properties. Such results are presented as representative embodiments rather than as universal promises for every solver and every material system. Nevertheless, the disclosed framework can provide a technically meaningful improvement by altering the solver at a point that precedes the principal iterative loop, thereby addressing bias or overscreening behavior at an earlier stage than a purely downstream correction strategy.

In some embodiments, the disclosed corrected outputs are used by downstream machine logic rather than merely displayed for human review. By way of example, a workflow may automatically accept, reject, rank, export, cache, enqueue, retrigger, or block a downstream computation based on one or more corrected electronic-structure properties, convergence metrics, or verification conditions generated by the disclosed solver execution. In this manner, the disclosed technology may function as part of a machine-control and machine-decision pipeline rather than merely as a passive reporting mechanism.

In additional embodiments, the disclosed technology provides an implementation advantage in that it may be incorporated into existing host solvers with limited code disruption. Representative embodiments described herein include compact source-level patches, linked libraries, plugins, injectors, or equivalent software integration techniques. In such implementations, core solver subsystems such as FFT libraries, diagonalization routines, mixing logic, pseudopotential handling, and general input/output infrastructure may remain unchanged, while the disclosed scaling is inserted at one or more selected computational points. This can simplify adoption, reduce engineering burden, and facilitate integration into established solver ecosystems.

In further embodiments, another advantage is breadth of applicability across solver types. The disclosed correction may be used not only in reciprocal-space DFT workflows, but also in hybrid DFT, GW, all-electron, time-dependent density-functional, quantum Monte Carlo, machine-learning-reference-generation, cloud-deployment, and downstream simulation contexts, as described elsewhere herein. This breadth can allow a single correction framework to be used across multiple computational products, pipelines, and technical domains without requiring an entirely separate correction philosophy for each environment.

In some embodiments, the disclosed technology also provides traceability and determinism advantages. Because the correction may be computed from disclosed equations, retrieved from a certified store, cross-checked through formal-verification infrastructure, or logged through runtime attestation mechanisms, the resulting workflow may be more amenable to reproducibility, auditability, and enterprise or regulated deployment than ad hoc manual tuning approaches. In representative embodiments, the same derivation path yields the same correction value for the same inputs, which can simplify validation and quality assurance.

Accordingly, the disclosed technology can provide one or more of the following representative advantages: elimination of empirical mixing-parameter selection, improved convergence behavior, reduced iteration count, reduced wall time, improved agreement with experimental reference values in representative benchmarks, limited implementation burden, compatibility with existing solver architectures, deterministic operation, optional provenance support, and adaptability across multiple computational environments. These advantages may be realized individually or in combination depending on the embodiment, solver platform, material system, and deployment context, and no particular advantage is required in every embodiment unless expressly recited in a claim.

1. A computer-implemented method for electronic-structure calculation, the method comprising: computing a correction parameter delta_loop according to delta_loop=X_opt\hat{ }(1+R_RP), where phi=(1+sqrt(5))/2, X_opt=phi/pi, and R_RP=7/12; computing a loop multiplier lambda_loop according to lambda_loop=1−delta_loop; before a first self-consistent-field iteration, scaling at least one exchange-related quantity and at least one correlation-related quantity of an electronic-structure solver by lambda_loop; executing, with one or more processors, an iterative electronic-structure workflow using the scaled quantity or quantities without further iterative rescaling of the scaled quantity or quantities; and outputting one or more electronic-structure properties comprising at least one of a band structure, a band gap, a total energy, a density of states, a charge density, or a quasiparticle energy.

2. The method of claim 1, wherein the electronic-structure solver comprises a Kohn-Sham density-functional theory solver or a hybrid density-functional theory solver.

3. The method of claim 1, wherein scaling the at least one exchange-related quantity and the at least one correlation-related quantity comprises scaling an exchange kernel Kx and a correlation kernel Kc according to Kx′(G)=Kx(G)*lambda_loop and Kc′(G)=Kc(G)*lambda_loop.

4. The method of claim 3, wherein an exchange-correlation contribution is represented according to E_xc=sum over G of ([Kx(G)+Kc(G)]*rho(G)).

5. The method of claim 3, wherein scaling comprises an in-place vector-scaling operation on one or more arrays.

6. The method of claim 5, wherein the in-place vector-scaling operation comprises one or more BLAS scaling calls.

7. The method of claim 1, wherein the scaling is performed during a pre-self-consistent-field initialization stage.

8. The method of claim 1, wherein the electronic-structure solver is implemented in a plane-wave code using reciprocal-space arrays.

9. The method of claim 1, wherein the scaling by the loop multiplier is performed after an exchange-correlation contribution is computed and before constructing an initial Hamiltonian or effective potential for a first self-consistent-field iteration.

10. The method of claim 1, wherein the scaling by the loop multiplier is performed during a pre-self-consistent-field initialization stage, and wherein the iterative electronic-structure workflow is executed using the scaled quantity or quantities without applying a subsequent iterative rescaling of the scaled quantity or quantities within the self-consistent-field loop.

11. The method of claim 1, wherein the iterative electronic-structure workflow comprises a GW workflow, and wherein scaling by the loop multiplier is applied to at least one of: (i) a screened interaction, (ii) an inverse dielectric quantity, or (iii) a self-energy quantity, and wherein the GW workflow is executed using the scaled screened interaction, the scaled inverse dielectric quantity, or the scaled self-energy quantity.

12. The method of claim 1, further comprising at least one of: (i) retrieving or validating at least one of delta_loop or lambda_loop using a certified constant source or a provenance store, or (ii) generating a provenance record that stores at least one of delta_loop or lambda_loop.

13. A system for electronic-structure calculation, the system comprising: one or more processors; and a memory storing instructions that, when executed by the one or more processors, cause the system to: compute a correction parameter delta_loop according to delta_loop=X_opt\hat{ }(1+R_RP), where phi=(1+sqrt(5))/2, X_opt=phi/pi, and R_RP=7/12; compute a loop multiplier lambda_loop according to lambda_loop=1−delta_loop; before a first iterative solver cycle begins, apply lambda_loop to at least one exchange-related quantity and at least one correlation-related quantity associated with an electronic-structure solver; execute the electronic-structure solver using the scaled quantity or quantities; and generate one or more output properties comprising at least one of a band structure, a band gap, a density of states, a total energy, or a quasiparticle energy.

14. The system of claim 13, wherein the system is configured as a plugin, patch set, linked library, injector, wrapper, or runtime extension for a host electronic-structure code.

15. The system of claim 13, wherein the host electronic-structure code comprises VASP, Quantum ESPRESSO, BerkeleyGW, or an equivalent electronic-structure code.

16. The system of claim 13, wherein the system is configured to apply the scaling through an array-scaling interface without modification of at least one FFT library, diagonalization routine, or density-mixing routine of the host electronic-structure code.

17. A non-transitory computer-readable medium storing instructions that, when executed by one or more processors, cause a computing system to: compute a correction parameter delta_loop according to delta_loop=X_opt\hat{ }(1+R_RP), where phi=(1+sqrt(5))/2, X_opt=phi/pi, and R_RP=7/12; compute a loop multiplier lambda_loop according to lambda_loop=1−delta_loop; before execution of a first iterative solver cycle, scale at least one exchange-related quantity and at least one correlation-related quantity of an electronic-structure workflow by lambda_loop; execute the electronic-structure workflow using the scaled quantity or quantities;
and store or output one or more resulting electronic-structure properties.

18. The non-transitory computer-readable medium of claim 17, wherein the instructions further cause the computing system to execute a GW workflow.

19. The non-transitory computer-readable medium of claim 18, wherein the instructions further cause the computing system to apply the loop multiplier to a screened interaction, an inverse dielectric quantity, a self-energy quantity, or a combination thereof.

20. The non-transitory computer-readable medium of claim 19, wherein the screened interaction is scaled according to W′(q, omega)=W(q, omega)*lambda_loop or the inverse dielectric quantity is scaled according to epsilon_inv′(q, omega)=epsilon_inv(q, omega)*lambda_loop.
